(19) United States
(12) Patent Application Publication
(10) Pub. No.: US 2025/0170660 A1
(43) Pub. Date: May 29, 2025

(54) END MILL

(71) Applicant: Haimer GmbH, Hollenbach-Igenhausen (DE)

(72) Inventor: Reinhold Sanhieter, Hollenbach-Igenhausen (DE)

(21) Appl. No.: 18/954,600

(22) Filed: Nov. 21, 2024

(30) Foreign Application Priority Data
Nov. 24, 2023 (DE) 10 2023 132 906.5

(51) Int. Cl. B23C 5/10

(52) U.S. Cl. CPC B23C 5/10

(57) ABSTRACT

An end mill, preferably formed of solid carbide, includes a fastening portion and a cutting region. The cutting region has cutting edges about a core extending helically about a rotation axis of the end mill, each cutting edge having one circumferential primary and one secondary cutting edge on an end side of the cutting region. The end side of the cutting region has first and second point thinnings of the core between mutually adjacent cutting edges. The first and second point thinnings are configured differently. The first point thinning has an angle of 30° to 45°, and the second point thinning has an angle of 35° to 50°, in terms of a normal plane to the rotation axis. The first point thinning has an opening angle of 30° to 50°, and the second point thinning has an opening angle of 40° to 60°, between flanks of the point thinning.

### CROSS-REFERENCE TO RELATED APPLICATION

This application claims the priority, under 35 U.S.C. § 119, of German Patent Application DE 10 2023 132 906.5, filed Nov. 24, 2023; the prior application is herewith incorporated by reference in its entirety.

### FIELD AND BACKGROUND OF THE INVENTION

The invention relates to an end mill for the subtractive machining of metallic materials, in particular steel and titanium, having a fastening portion and a cutting region, wherein the cutting region is formed by a core and at least two cutting edges which are disposed about the core and extend helically about a rotation axis of the end mill, each of the cutting edges having in each case one circumferential primary cutting edge and one secondary cutting edge on an end side of the cutting region, provided on the end side of the cutting region is at least one first point thinning of the core between two mutually adjacent cutting edges, and at least one second point thinning between two mutually adjacent cutting edges.

An end mill which has a fastening portion and a cutting region is known from German Patent Application DE 10 2015 116 623 A1, corresponding to U.S. Publications 2017/0087646 A1 and 2018/0297128 A1. The cutting region is formed by a rotationally symmetrical core and, in that case, four cutting edges which are disposed helically about the core and are integrally connected to the core.

The four cutting edges have in each case one circumferential primary cutting edge and one secondary cutting edge on a free end side of the cutting region. It is achieved as a result that a good surface quality is achieved when face milling using the secondary cutting edges.

However, in end mills of that type there is the disadvantage that they are not suitable for boring operations, thus subtractive machining using the end side-proximal secondary cutting edges, in the case of a feeding direction which is substantially along the rotation axis of the end mill, because there are no cutting edges located in the region close to the center.

A boring operation is difficult even in the case of tools in which at least part of the cutting edges extends substantially up to the rotation axis of the end mill, because the necessary chip removal cannot be reliably guaranteed.

Furthermore, in order to also enable a boring operation, or subtractive machining, on the entire end side, the end mill of German Patent Application DE 10 2015 116 623 A1, corresponding to U.S. Publications 2017/0087646 A1 and 2018/0297128 A1, provides a point thinning of the core between respective mutually adjacent cutting edges on its end side.

In the end mill of German Patent Application DE 10 2015 116 623 A1, corresponding to U.S. Publications 2017/0087646 A1 and 2018/0297128 A1, the point thinnings are sized between 30° and 40° (between the second cutting edge and the third cutting edge, as well as between the fourth cutting edge and the first cutting edge), and 20° and 40° (between the first cutting edge and the second cutting edge, as well has between the third cutting edge and the fourth cutting edge), respectively.

German Patent Application DE 10 2015 116 623 A1, corresponding to U.S. Publications 2017/0087646 A1 and 2018/0297128 A1, provides, or sizes, its point thinning angles as mentioned in relation to the rotation axis of the end mill.

When measured in terms of, for example, an end side-proximal normal plane to the rotation axis of the end mill, the end mill of Patent Application DE 10 2015 116 623 A1, corresponding to U.S. Publications 2017/0087646 A1 and 2018/0297128 A1, provides point thinnings between 50° and 60° (between the second cutting edge and the third cutting edge, as well as between the fourth cutting edge and the first cutting edge), and 50° and 70° (between the first cutting edge and the second cutting edge, as well as between the third cutting edge and the fourth cutting edge), respectively. This means that the point thinning angle provided with dimensions there is the angle which is enclosed between (1) a connecting/straight line of a deepest point of the point thinning, i.e. a point which is axially the most remote from the end side, connected to the penetration point of the rotation axis of the end mill through the end side-proximal normal plane of the end mill and (2) the end side-proximal normal plane.

The end mill of German Patent Application DE 10 2015 116 623 A1, corresponding to U.S. Publications 2017/0087646 A1 and 2018/0297128 A1, thus provides very steeply extending point thinnings, which indeed improves the boring operation, which however comes at the expense of the tooth thickness and tooth stability, and thus the stiffness of the end mill and the quality when face milling.

### SUMMARY OF THE INVENTION

It is accordingly an object of the invention to provide an improved end mill, which overcomes the hereinafore-mentioned disadvantages of the heretofore-known devices of this general type and which, in particular, enables a positive quality when face milling as well as in boring operations.

Advantageous refinements of the invention of the subject matter of dependent claims and of the description hereunder.

Any terms used, such as above, below, front, rear, left or right—unless explicitly defined otherwise—are to be understood according to the usual understanding—also with regard to the present figures. Terms such as radial and axial, where used and not explicitly defined otherwise, are to be understood with reference to central or symmetry axes of components described herein—also with regard to the present figures.

The term “substantially”—where used—can be understood (according to the highest court's understanding) as referring to “a practically still considerable extent.” Possible deviations from exactness that are thus implied by this term may therefore arise unintentionally (that is to say without any functional basis) due to manufacturing or assembly tolerances or similar.

The end mill, preferably made of solid carbide, provides a fastening portion and a cutting region. The cutting region is formed by a core and at least two, in particular four (or an even greater even number of (for example six or eight)) cutting edges which are disposed about the core and extend helically about a rotation axis of the end mill, each of the cutting edges having in each case one circumferential primary cutting edge and one secondary cutting edge on an end side of the cutting region, i.e. one end side-proximal secondary cutting edge.

Provided on the end side of the cutting region are at least one first point thinning of the core between (first) two mutually adjacent cutting edges, and at least one second point thinning between two (other, or second) mutually adjacent cutting edges.

The end mill is furthermore distinguished in that the first point thinning is—geometrically-configured differently from the second point thinning, or is different from the second point thinning—in geometric terms. In other words, put simply, the end mill implements at least two—geometrically-different point thinnings.

Furthermore, the first point thinning is to have a (point thinning) angle of 30° to 45°, in particular of 32° to 38°, especially approximately 35°, and the second point thinning is to have a (point thinning) angle of 35° to 50°, in particular of 39° to 46°, especially approximately 42.5° (always in terms of a (for example, end side-proximal) normal plane to the rotation axis of the end mill).

In the end mill herein, the point thinning angle is to be measured or stated in terms of a, for example, end side-proximal, normal plane to the rotation axis of the end mill. This means that the point thinning angle measured here is the angle which is enclosed between (1) a connecting/straight line of a deepest point of the point thinning, i.e. a point which is axially the most remote from the end side, connected to the penetration point of the rotation axis of the end mill through the end side-proximal normal plane of the end mill and (2) the end side-proximal normal plane.

Moreover, the first point thinning is to have an opening angle of 30° to 50°, in particular of 35° to 45°, especially of approximately 40°, and the second point thinning is to have an opening angle of 40° to 60°, in particular of 41° to 50°, especially of approximately 42.5° (the opening angle always being the angle between the flanks of the point thinning in top view onto the end side of the end mill).

The point thinning opening angle herein is to be measured as the angle between the flanks of the point thinning in top view onto the end side of the end mill. In other words, the flanks of the point thinning, in top view onto the end side of the end mill, converge at an angle which appears in that perspective, specifically here the point thinning opening angle. (The tip of the angle may optionally also be radiused.)

Point thinning herein can include any structural embodiment by way of which the material of the core, and potentially also of the cutting edges in the region of the end side of the cutting edge region, is reduced to a limited local extent in the circumferential direction between the cutting edges.

The core is understood to mean the rotationally symmetrical core region of an end mill in the cutting region. The cutting edges are disposed about this core and formed integrally with the core. The base of each chip removal groove, the latter being formed in the circumferential direction between the cutting edges, is delimited by the core.

In an advantageous embodiment, the point thinning can be formed as a clearance in the region of the end side of the cutting region, which approaches the rotation axis of the end mill in the direction from the fastening portion to the end side of the cutting region. A clearance of this type can be particularly easily achieved by grinding, for example.

The end mill is based on the knowledge or concept, that the capability of the end mill in terms of boring operations increases or is improved as the point thinning angle increases, the point thinning angle thus becoming larger or steeper. However, the tooth thickness decreases as the point thinning increases, or the point thinning angle becomes larger/steeper, this compromising, or potentially compromising, the strength and the stiffness of the end mill and its quality when face milling.

Proceeding from this knowledge, the end mill according to the invention now attempts to find a compromise in terms of these competing requirements, i.e. of chip removal and stability of, or in, the boring operation and when face milling.

It has been surprisingly demonstrated here that when a larger first point thinning angle, which facilitates the boring operation but possibly compromises the face milling, is implemented, the possibly “compromising aspect” can be “compensated for” by a smaller second point thinning angle which is also implemented simultaneously, thus meeting, or being able to meet, the competing requirements.

However, as has likewise been demonstrated, the two different “competing” point thinnings should not, or must not, lie in extreme marginal ranges (e.g. less than 20° or more than) 70°, on the one hand, and on the other hand cannot be too far apart, or deviate too much, from one another, because the competing effects can otherwise no longer be levelled out or compensated for in the case of such bilateral “extremes” (both absolute and relative).

The same applies in an analogous manner for the (point thinning) opening angles provided by the end mill. In this case too, large (point thinning) opening angles make sufficient space for the chip removal and/or have a positive effect on the boring operation, but remove material from the teeth, which also reduces the stiffness. Here too, the first and the second (point thinning) opening angle also achieve a compromise between the competing effects, or can compensate for the latter, as has been surprisingly demonstrated.

This means that the end mill according to the invention, by way of its “balanced distribution” of point thinnings—of a first smaller point thinning, on the one hand, and a second larger point thinning which (in terms of value) is not too far apart from the first point thinning—in the middle range of point thinnings—achieves the feat of “reconciling” the opposite effects, or of compensating for the latter, and of thus achieving a positive compromise between good boring operation and face milling (or sufficient stiffness for those).

Moreover, such an end mill according to the invention, due to its “balanced distribution of point thinnings”—is also easy and cost effective to produce.

Specifically in order to implement the balance and compensation, it can preferably be provided that the first point thinning has a (point thinning) angle of 32° to 38°, in particular of approximately 35°, and the second point thinning has a (point thinning) angle of 39° to 46°, in particular of approximately 42.5°.

The same applies in an analogous manner also to preferred point thinning opening angles which can preferably be implemented in such a way that the first point thinning has an opening angle of 35° to 45°, in particular of approximately 40°, and the second point thinning has an opening angle of 41° to 50°, in particular of approximately 42.5°.

It also appears particularly advantageous when a plurality of the first and the second point thinnings are implemented, wherein the first and the second point thinnings mutually alternate in the circumferential direction on the end side of the end mill.

It also appears expedient when the end side-proximal secondary cutting edge of a first cutting edge of a first tooth is longer than the end side-proximal secondary cutting edge of a second cutting edge of a second tooth, wherein the first point thinning conjointly forms the chip space of the first cutting edge, or of the first tooth, and the second point thinning conjointly forms the chip space of the second cutting edge, or of the second tooth.

Likewise, a plurality of the first teeth, or of the first cutting edges having the longer end side-proximal secondary cutting edges, and the chip spaces with the first point thinnings, as well as a plurality of the second teeth, or of the second cutting edges having the shorter end side-proximal secondary cutting edges, and the chip spaces with the second point thinnings, can be provided, wherein the longer end side-proximal secondary cutting edges, by way of their respective first point thinnings, and the shorter end side-proximal secondary cutting edges by way of their respective second point thinnings, mutually alternate in the circumferential direction of the cutting portion on the end side of the end mill.

It also proves expedient when the first and the second point thinning—proceeding from the end side—terminate substantially at the same axial height in the cutting region.

According to a—preferred-structural embodiment it can be provided that the cutting region includes a total of four cutting edges, of which a first cutting edge and a third cutting edge, as well as a second cutting edge and a fourth cutting edge, lie—substantially-opposite one another, or approximately diametrically opposite one another, and the first point thinning is provided between the first cutting edge and the second cutting edge, as well as between the third cutting edge and the fourth cutting edge, and the second point thinning is provided between the second cutting edge and the third cutting edge as well as between the fourth cutting edge and the first cutting edge.

It furthermore also proves advantageous when the cutting edges are non-uniformly distributed in the circumferential direction of the cutting region. Such a non-uniform distribution can be established, for example, in terms of a predefinable axial height, in particular for the end face of the end mill (corresponds to height 0 mm) or a height of approximately 0.5*D (D=diameter of the cutting region) axially below the end face of the end mill.

It can in particular also be provided herein, i.e. in the non-uniform distribution mentioned, that in the circumferential direction of the cutting region, and at a predefinable axial height in the cutting region, the angle between the first cutting edge and a second cutting edge, and between the third cutting edge and the fourth cutting edge, is in each case more than 90°, in particular approximately 97.5°, and/or the angle between the second cutting edge and the third cutting edge, and between the fourth cutting edge and the first cutting edge, is in each case less than 90°, in particular approximately 82.5°, in particular that the predefinable axial height is the end face of the end mill (corresponds to height 0 mm) or is approximately 0.5*D (D=diameter of the cutting region) axially below the end face of the end mill.

It can also be provided that the circumferential primary cutting edges of the cutting edges have different helix angles, in particular the circumferential primary cutting edges of the cutting edges in the circumferential direction of the cutting region have a first helix angle alternating with a second helix angle, the latter differing from the first helix angle.

It may also be expedient to implement particular geometries in the cutting edges.

In this way, it can be provided that the end face of a, in particular of each, cutting edge on the secondary cutting edge has a relief angle between 5° and 7°, in particular approximately 6°, in relation to a plane perpendicular to the rotation axis of the end mill.

It can also be provided that the chip space-proximal (end) face of a, in particular of each, secondary cutting edge has a rake angle between 2° and 4°, in particular approximately 3°, in relation to a plane parallel to the rotation axis of the end mill.

It can furthermore be provided that the end side-proximal secondary cutting edge and the circumferential primary cutting edge of a cutting edge transition into one another by way of a corner bevel, in particular having a corner bevel angle of approximately 45°.

It also proves expedient when the core of the end mill is of cylindrical construction.

In a preferred structural embodiment it can furthermore be provided that at least the cutting region is coated, in particular having a coating with a layer thickness between 0.0010 mm and 0.006 mm, in particular between 0.0015 mm and 0.005 mm, especially between 0.0018 mm and 0.004 mm.

It also proves advantageous when the end mill is made of solid carbide.

The description given so far of advantageous configurations of the invention includes numerous features that are reproduced in the individual dependent claims, in some cases together. However, these features may expediently also be considered individually and combined into appropriate further combinations.

Even though some terms are used in each case in the singular or in combination with a numeral in the description and/or in the patent claims, the scope of the invention is not intended to be limited to the singular or the respective numeral for these terms. Furthermore, the words “a” or “an” are not to be understood as numerals, but rather as indefinite articles.

The properties, features and advantages of the invention described above and the manner in which they are achieved will become clearer and more clearly understandable in conjunction with the following description of the exemplary embodiments of the invention, which are explained in greater detail in conjunction with the drawings/figures (the same components and functions have the same designations in the drawings/figures).

The exemplary embodiments are used to explain the invention and do not restrict the invention to combinations of features, including with respect to functional features, that are specified therein. Furthermore, it is possible to this end for suitable features of each exemplary embodiment also to be considered explicitly in isolation, to be taken from one exemplary embodiment, introduced into another exemplary embodiment to supplement it and combined with any one of the claims.

### BRIEF DESCRIPTION OF THE FIGURES

FIG. 1 is a lateral view of a solid carbide end mill having a cutting region and a fastening portion, according to an embodiment of the invention;

FIG. 2 is a frontal view of the free end side of the solid carbide end mill from FIG. 1;

FIG. 3 is a view of the free end side of the solid carbide end mill from FIG. 1;

FIG. 4-1 (point thinning long tooth) and FIG. 4-2 (point thinning short tooth) are each a lateral view of the solid carbide end mill, having the point thinning respectively at a long tooth, or a short tooth, from FIG. 1.

### DETAILED DESCRIPTION OF THE INVENTION

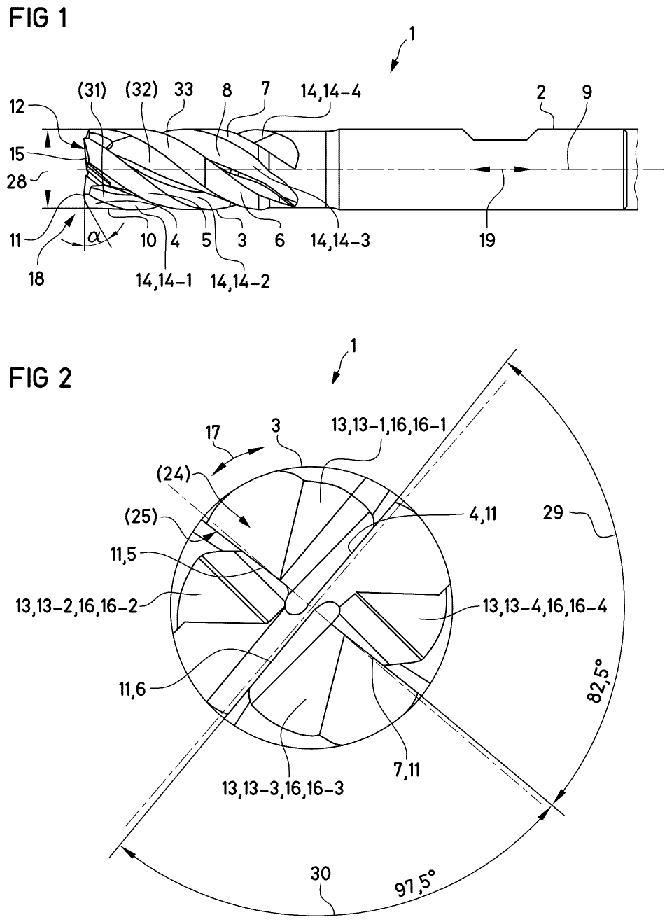

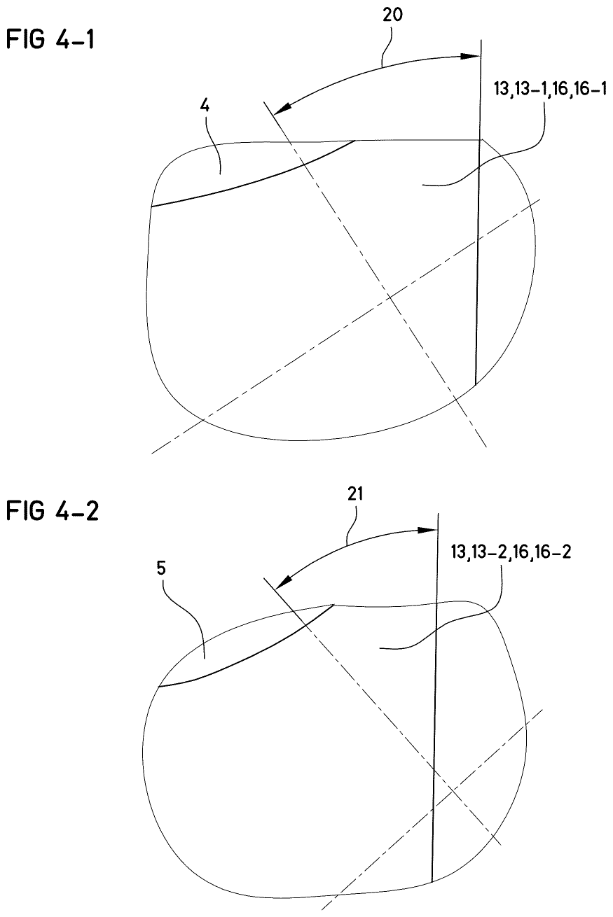

### (Solid Carbide) End Mill (FIGS. 1 and 4)

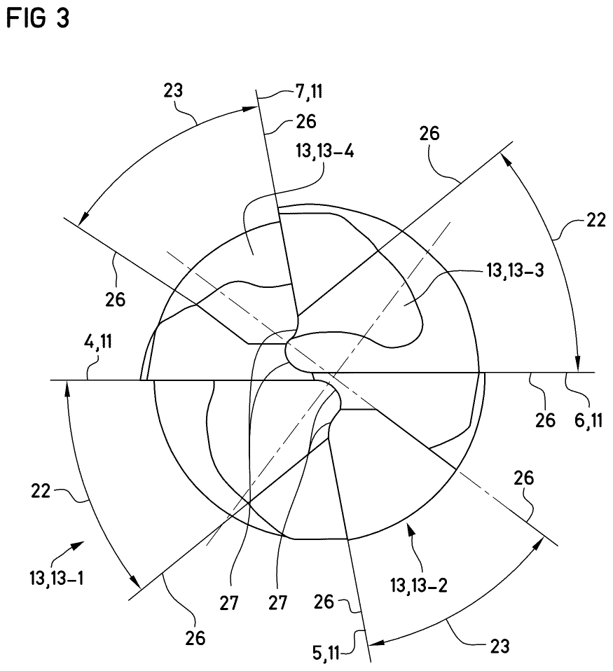

Referring now to the figures of the drawings in detail and first, particularly, to FIGS. 1 and 2 thereof, there is seen (schematically)—in various views and details—an end mill 1 (from solid carbide). FIG. 1 here shows the solid carbide end mill 1 in a lateral view; FIG. 2 shows the solid carbide end mill 1 in a frontal view of its (free) end side 12. FIGS. 3 to 4 show in each case views—from different perspectives (end side, side)—of the solid carbide end mill 1.

The solid carbide end mill 1 has a fastening portion 2 and a cutting region 3 having—in this case—four teeth 4, 5, 6 and 7, or four cutting edges 4, 5, 6 and 7.

The fastening portion 2 has a cylindrical shape and is configured to be received in a chuck of a workpiece machining machine such as, for example, a CNC milling center (not shown).

Adjoining the fastening portion 2 is the cutting region 3 which is formed by a core 8—which in this case is of a cylindrical configuration—and by the cutting edges 4, 5, 6 and 7, or the teeth 4, 5, 6 and 7, which are disposed about the core 8.

The cutting edges/teeth 4, 5, 6 and 7 herein extend helically about a rotation axis 9 of the solid carbide end mill 1 and are integrally formed with the (cylindrical) core 8.

Each cutting edge 4, 5, 6 and 7 has in each case one circumferential primary cutting edge 10 and an (end side-proximal) secondary cutting edge 11 on an end side 12 of the cutting region 3, the cutting edges being configured to interact in a subtractive manner with the workpiece to be machined (not shown) during a rotation of the solid carbide end mill 1 about the rotation axis 9.

For improved clarity, the reference signs for the primary cutting edge 10 and the secondary cutting edge 11 are not fully included for all cutting edges 4, 5, 6 and 7 in the illustration in the figures; however, each cutting edge 4, 5, 6 and 7 has a (circumferential) primary cutting edge 10 as well as an (end side-proximal) secondary cutting edge 11.

As is also shown in FIG. 2, the end side-proximal secondary cutting edges 11 of the cutting edges 4 and 6 herein are longer than the end side-proximal secondary cutting edges 11 of the cutting edges 5 and 7. For this reason, reference hereunder is also made to “long teeth” 4 and 6 in the case of the—“long”-cutting edges 4 and 6, and to “short teeth” 5 and 7 in the case of the—“short”-cutting edges 5 and 7.

The end side-proximal secondary cutting edges 11 and the circumferential primary cutting edges 10 of all cutting edges 4, 5, 6 and 7 transition into one another in each case by way of a corner bevel 18, in particular having a corner bevel angle a of approximately 45°.

Moreover, provided in the region of the end side 12 of the cutting region 3—in this case corresponding to the number of the four cutting edges 4, 5, 6 and 7—are four point thinnings 13-1, 13-2, 13-3 and 13-4 of the core 8, each of them conjointly forming the chip removal space 16-1, 16-2, 16-3 and 16-4, respectively, of the respective cutting edge 4, 5, 6 and 7 (point thinning 13-1 for the cutting edge 4, point thinning 13-2 for the cutting edge 5, point-thinning 13-3 for the cutting edge 6, and point thinning 13-4 for the cutting edge 7).

As a result of these point thinnings 13-1, 13-2, 13-3 and 13-4, the core 8 in the circumferential direction 17 of the solid carbide end mill 1 is reduced in the cross section-in a locally restricted manner-between the cutting edges 4, 5, 6 and 7.

The point thinnings 13-1, 13-2, 13-3 and 13-4 are in each case formed as clearances which, in the region of the end side 12 of the cutting region 3 in the chip removal grooves 14-1, 14-2, 14-3, and 14-4 between the respective cutting edges 4, 5, 6 and 7, are generated—for example by grinding—and approach the rotation axis 9 of the solid carbide end mill 1 in the direction from the fastening portion 2 to the end side 12 of the cutting region 3 (point thinning 13-1 to the chip removal groove 14-1, point thinning 13-2 to the chip removal groove 14-2, point thinning 13-3 to the chip removal groove 14-3, and point thinning 13-4 to the chip removal groove 14-4).

The point thinnings 13-1, 13-2, 13-3, 13-4 herein are chosen in such a manner that the first and the third point thinning 13-1 and 13-3 are (geometrically) mutually identical and differ (geometrically) from the second and the fourth point thinning 13-2 and 13-4 (the latter in turn also being (geometrically) mutually identical).

Furthermore, the first and the third point thinning 13-1 and 13-3, respectively, should have a (point thinning) angle 20 from the range of 30° to 45°, presently approximately 35° (cf. FIG. 4-1), and the second and fourth point thinning 13-2 and 13-4, respectively, should have a (point thinning) angle 21 from the range of 35° to 50°, presently approximately 42.5° (cf. FIG. 4-2) (always in terms of a (for example end side-proximal) normal plane to the rotation axis of the end mill).

Moreover, the first and the third point thinning 13-1 and 13-3, respectively, should have a (point thinning) opening angle 22 from the range of 30° to 50°, presently approximately 40°, and the second and fourth point thinning 13-2 and 13-4, respectively, should have a (point thinning) opening angle 23 from the range of 40° to 60°, presently approximately 42.5° (the opening angle always being the angle between the flanks of the point thinning in top view onto the end side of the end mill) (cf. FIG. 3).

When visualized in the top view onto the end side 12 shown in FIG. 3, the flanks 26 of the point thinnings 13-1/13-3 and 13-2/13-4, respectively, converge at an angle 22 and 23, respectively, appearing in the perspective, of 40° and 42.5°, respectively, wherein the tip in the direction of the rotation axis 9 is in each case radiused (radiusing 27), the radius—here by way of example—corresponding to 0.075 to 0.125 times the cutting region diameter 28 (for the point thinnings 13-1 and 13-3), and to 0.1 to 0.3 times the cutting region diameter 28 (for the point thinnings 13-2 and 13-4), respectively.

In simplified and visualized terms, this means that the first and the third point thinning 13-1 and 13-3, respectively, each being on the longer end side-proximal secondary cutting edges 11, are (geometrically) identical, just as the second and the fourth point thinning 13-2 and 13-4, respectively, each being on the shorter end side-proximal secondary cutting edges 11, are (geometrically) identical, wherein the second and the fourth point thinning 13-2 and 13-4 “extend more steeply and at a larger (point thinning) opening angle” than the first and the third point thinning 13-1 and 13-3, respectively. In this way, the two different point thinnings 13-1 and 13-3, respectively, and 13-2 and 13-4, respectively, mutually alternate—in the circumferential direction 17—on the end side 12 of the end mill.

Furthermore, the solid carbide end mill 1 provides that all point thinnings 13-1, 13-2, 13-3 and 13-4—proceeding at the end side (12)—terminate substantially at the same axial height (19) in the cutting region 3, so as to guarantee a uniform discharge of chips into the respective chip removal groove 14-1, 14-2, 14-3 and 14-4, respectively.

As is highlighted in particular in FIG. 1, the chip removal grooves 14-1, 14-2, 14-3 and 14-4 herein are in each case disposed between two adjacent (in the circumferential direction 17) cutting edges 4 and 5, or 5 and 6, or 6 and 7, or 7 and 4, respectively, of the teeth 4, 5, 6 and 7 and—conjointly with the point thinnings 13-1, 13-2, 13-3 and 13-4—serve to discharge the chips generated by the primary cutting edges 10 and the secondary cutting edges 11 of the cutting edges 4, 5, 6 and 7.

This means that the chip removal grooves 14 and the point thinnings 13, in each case conjointly, form the chip removal spaces 16 at the cutting edges/teeth 4, 5, 6 and 7.

As a result of the point thinnings 13-1, 13-2, 13-3 and 13-4, the cross section of the chip removal grooves 14-1, 14-2, 14-3 and 14-4 is enlarged in the region of the end side 12 of the cutting region 3, as a result of which chips, in particular from the center-proximal region of the (end side-proximal) secondary cutting edges 11 can be particularly well transported away (cf. introductory remarks in the context of the invention pertaining to the boring operation and the balanced characteristic of the point thinnings).

All cutting edges/teeth 4, 5, 6 and 7 have in each case a relief angle 24 of 5° to 7°, and in particular of 6°, which means that the angle between an end face 15 of each secondary cutting edge 11 and a (normal) plane perpendicular to the rotation axis 9 is 5° to 7°, or in particular 6°, respectively.

Likewise, all cutting edges/teeth 4, 5, 6 and 7 have in each case an (end) rake angle 25 of 2° to 4°, in particular presently of approximately 3°, which means that the chip space-proximal (end) face of a (i.e. presently each) secondary cutting edge 11 provides a rake angle 25 between 2° and 4°, in particular of approximately 3°, in relation to a plane parallel to the rotation axis 9 of the end mill.

As can also be derived from FIG. 2—highlighted by the auxiliary lines plotted in the latter—the cutting edges 4, 5, 6 and 7, the secondary cutting edges 11, conjointly with the primary cutting edges 10, are disposed so as to be non-uniformly distributed in the circumferential direction 17 of the solid carbide end mill 1, this promoting the stability of the cutting edges 4, 5, 6 and 7 and reducing vibrations.

As stated, this non-uniformity relates to a normal plane (to the rotation axis 9) which lies axially 19 (in the direction of the rotation axis 9) below the end side 12 by approximately 0.5*D (D=diameter of the cutting region 3 of the solid carbide end mill 1).

In this way, the first cutting edge 4 and the third cutting edge 6, as well as the second cutting edge 5 and the fourth cutting edge 7—at the end side 12—lie approximately opposite one another, or approximately diametrically opposite one another, but the angle between the first cutting edge 4 and the adjoining (in the clockwise direction) fourth cutting edge 7, and between the third cutting edge 7 and the adjoining (in the clockwise direction) second cutting edge 5 is in each case configured to be less than 90° (first angular pitch 29), particularly preferably to be approximately 82.5°. This means that the angle between the fourth cutting edge 7 and the adjoining (in the clockwise direction) third cutting edge 6, as well as between the second cutting edge 5 and the adjoining (in the clockwise direction) first cutting edge 4 is more than 90° and is preferably approximately 97.5° (second angular pitch 30).

Because the helix angle of the cutting edges 4 and 6, presently approximately 36.5° (first helix angle 31) differs from that of the cutting edges 5 and 7, presently approximately 38° (second helix angle 32), this results in an unequal pitch of the cutting edges 4, 5, 6 and 7 in almost all axial 19 normal planes in terms of the rotation axis 9 of the solid carbide end mill 1 in the region of the axial extent 19 of the point thinnings 13-1, 13-2, 13-3 and 13-4 (this unequal pitch of the cutting edges 4, 5, 6 and 7 in the cutting region 3 varying along the rotation axis 9).

This unequal pitch of the cutting edges 4, 5, 6 and 7—by virtue of its advantageous stability—is particularly relevant in the region of the end side 12 of the cutting region 3, because the reduction of the cross section of the core 8 of the solid carbide end mill 1 as a result of the point thinnings 13-1, 13-2, 13-3 and 13-4 is the most pronounced here, in order to form and delimit the two long secondary cutting edges 11, which reach substantially up to the rotation axis 9, as well as to enable a discharge of chips from the secondary cutting edges 11 in the axial direction 19 close to the rotation axis 9.

This is particularly important in boring operations, because material has to be subtractively removed across the entire cross section of the cutting region 3 in the case of a bore in the solid material without a pilot bore.

Furthermore, it is also provided in the solid carbide end mill 1 that at least the cutting region 3 is coated, in particular having a coating 33 with a coating thickness between 0.0010 mm and 0.006 mm, particularly between 0.0015 mm and 0.005 mm, especially between 0.0018 mm and 0.004 mm.

While the invention has been illustrated and described in detail by the preferred exemplary embodiments, the invention is not limited by the disclosed examples and other variations may be derived therefrom without departing from the scope of protection of the invention.

The following is a summary list of reference numerals and the corresponding structure used in the above description of the invention:
1 Solid carbide end mill
2 Fastening portion
3 Cutting region
4 First cutting edge/first (long) tooth
5 Second cutting edge/second (short) tooth
6 Third cutting edge/third (long) tooth
7 Fourth cutting edge/fourth (short) tooth
8 (Cylindrical) core
9 Rotation axis
10 (Circumferential) primary cutting edge
11 (End side-proximal) secondary cutting edge
12 End side of the solid carbide end mill, or of the cutting region, respectively
13 or 13-1,
13-2, 13-3,
13-4 Point thinnings
14 or 14-1,
14-2, 14-3,
14-4 Chip removal grooves
15 End face
16 or 16-1,
16-2, 16-3,
16-4 Chip removal spaces
17 Circumferential direction
18 Corner bevel
19 Axial direction, “axial”
20 (Point thinning) angle for the first and the third point thinning 13-1 and 13-3, respectively
21 (Point thinning) angle for the second and the fourth point thinning 13-2 and 13-4, respectively
22 (Point thinning) opening angle for the first and the third point thinning 13-1 and 13-3, respectively
23 (Point thinning) opening angle for the second and the fourth point thinning 13-2 and 13-4, respectively
24 Relief angle
25 (Frontal) rake angle
26 Flank
27 Radiusing
28 Cutting region diameter
29 First angular pitch
30 Second angular pitch
31 First helix angle
32 Second helix angle
33 Coating
α Corner bevel angle

1. An end mill, comprising:
a fastening portion and a cutting region;
said cutting region having an end side and said cutting region being formed by a core and at least two cutting edges, said at least two cutting edges being disposed about said core and extending helically about a rotation axis of the end mill;
each of said cutting edges having one respective circumferential primary cutting edge and one respective secondary cutting edge on said end side of said cutting region;
said end side of said cutting region having at least one first point thinning of said core between a mutually adjacent two of said cutting edges, and at least one second point thinning between a mutually adjacent two of said cutting edges;
said at least one first point thinning being configured differently from said at least one second point thinning, said at least one first point thinning having a angle of 30° to 45°, and said at least one second point thinning having a angle of 35° to 50°; and
said at least one first point thinning having an opening angle of 30° to 50°, and said at least one second point thinning having an opening angle of 40° to 60°.

2. The end mill according to claim 1, wherein said angle of said at least one first point thinning is 32° to 38°, and said angle of said at least one second point thinning is 39° to 46°.

3. The end mill according to claim 2, wherein said angle of said at least one first point thinning is approximately 35°, and said angle of said at least one second point thinning is approximately 42.5°.

4. The end mill according to claim 1, wherein said opening angle of said at least one first point thinning is 35° to 45°, and said opening angle of said at least one second point thinning is 41° to 50°.

5. The end mill according to claim 4, wherein said opening angle of said at least one first point thinning is approximately 40°, and said opening angle of said at least one second point thinning is approximately 42.5°.

6. The end mill according to claim 1, wherein said at least one first point thinning includes a plurality of first point thinnings, said at least one second point thinning includes a plurality of second point thinnings, and said first and second point thinnings mutually alternate in a circumferential direction on said end side.

7. The end mill according to claim 1, wherein:
said cutting edges include a first cutting edge of a first tooth having said end side-proximal secondary cutting edge and a second cutting edge of a second tooth having said end side-proximal secondary cutting edge;
said end side-proximal secondary cutting edge of said first cutting edge of said first tooth is longer than said end side-proximal secondary cutting edge of said second cutting edge of said second tooth; and
said at least one first point thinning conjointly forms a chip space of said first cutting edge, or of said first tooth, and said at least one second point thinning conjointly forms a chip space of said second cutting edge, or of said second tooth.

8. The end mill according to claim 7, which further comprises:
a plurality of said first teeth, or of said first cutting edges having said longer end side-proximal secondary cutting edges, and said chip spaces with said at least one first point thinnings, as well as a plurality of said second teeth, or of said second cutting edges having said shorter end side-proximal secondary cutting edges, and said chip spaces with said at least one second point thinnings;
said longer end side-proximal secondary cutting edges, by way of their respective first point thinnings, and said shorter end side-proximal secondary cutting edges, by way of their respective second point thinnings, mutually alternating in a circumferential direction of said cutting portion on said end side.

9. The end mill according to claim 1, wherein said at least one first and said at least one second point thinnings, proceeding from said end side, terminate substantially at an equal axial height in said cutting region.

10. The end mill according to claim 1, wherein:
said cutting edges in said cutting region include a total of first, second, third and fourth cutting edges, said first cutting edge and said third cutting edge, as well as said second cutting edge and said fourth cutting edge, lying substantially opposite one another, or approximately diametrically opposite one another;
said at least one first point thinning is disposed between said first cutting edge and said second cutting edge, as well as between said third cutting edge and said fourth cutting edge; and
said at least one second point thinning is disposed between said second cutting edge and said third cutting edge, as well as between said fourth cutting edge and said first cutting edge.

11. The end mill according to claim 1, wherein said cutting edges are non-uniformly distributed in a circumferential direction of said cutting region.

12. The end mill according to claim 1, wherein:
said cutting edges in said cutting region include first, second, third and fourth cutting edges;
in a circumferential direction of said cutting region, and at a predefinable axial height in said cutting region, at least one of:
an angle between said first cutting edge and said second cutting edge, and between said third cutting edge and said fourth cutting edge, is in each case more than 90°, or
an angle between said second cutting edge and said third cutting edge, and between said fourth cutting edge and said first cutting edge, is in each case less than 90°; and
said predefinable axial height is at said end face corresponding to a height of 0 mm, or is approximately 0.5*D, where D is a diameter of said cutting region, axially below said end face.

13. The end mill according to claim 1, wherein:
said cutting edges in said cutting region include first, second, third and fourth cutting edges;
in a circumferential direction of said cutting region, and at a predefinable axial height in said cutting region, at least one of:
an angle between said first cutting edge and said second cutting edge, and between said third cutting edge and said fourth cutting edge, is in each case approximately 97.5°, or
an angle between said second cutting edge and said third cutting edge, and between said fourth cutting edge and said first cutting edge, is in each case approximately 82.5°; and
said predefinable axial height is at said end face corresponding to a height of 0 mm, or is approximately 0.5*D, where D is a diameter of said cutting region, axially below said end face.

14. The end mill according to claim 1, wherein said circumferential primary cutting edges of said cutting edges have different helix angles, said circumferential primary cutting edges of said cutting edges in a circumferential direction of said cutting region have a first helix angle alternating with a second helix angle, and said first and second helix angles are different.

15. The end mill according to claim 1, wherein said secondary cutting edges of said cutting edges have end faces with a relief angle between 5° and 7° relative to a plane perpendicular to said rotation axis of the end mill.

16. The end mill according to claim 1, wherein said secondary cutting edges have chip space-proximal faces with a rake angle of between 2° and 4° relative to a plane parallel to said rotation axis of the end mill.

17. The end mill according to claim 1, wherein said end side-proximal secondary cutting edge and said circumferential primary cutting edge of a cutting edge transition into one another by way of a corner bevel having a corner bevel angle of 45°.

18. The end mill according to claim 1, wherein said core has a cylindrical shape.

19. The end mill according to claim 1, wherein at least said cutting region is coated with a coating having a layer thickness of between 0.0010 mm and 0.006 mm.

20. The end mill according to claim 1, wherein the end mill is a solid carbide end mill.
